(19) United States
(12) Patent Application Publication
(10) Pub. No.: US 2004/0145466 A1
(43) Pub. Date: Jul. 29, 2004

(54) Apparatus and method for detecting and mitigating a stovetop fire

(75) Inventors: Richard Anthony, Fort Worth, TX (US); Michael Custer, Fort Worth, TX (US); Kartik Moorthy, Lewisville, TX (US); Matthew B. Scarpino, Fort Worth, TX (US); Aravind Seshadri, Fort Worth, TX (US); Brent Williams, Fort Worth, TX (US)

Correspondence Address: DECKER, JONES, MCMACKIN, MCCLANE, HALL &, BATES, P.C., BURNETT PLAZA 2000, 801 CHERRY STREET, UNIT #46, FORT WORTH, TX, 76102-6836, US

(73) Assignee: Williams-Pyro, Inc.

(21) Appl. No.: 10/626,329

(22) Filed: Jul. 24, 2003

Related U.S. Application Data
(60) Provisional application No. 60/399,454, filed on Jul. 30, 2002.

(51) Int. Cl. G08B 19/00

(52) U.S. Cl. 340/522; 340/584

(57) ABSTRACT

There is provided an apparatus that has a sensor unit located so as to monitor physical parameters of a stove top and a control unit that is positioned to turn off the stove top heating elements in response to the sensor unit. The sensor unit has an array of sensors such as ultraviolet, infrared, temperature, smoke, and combustion byproduct sensors. The sensor unit also has a microcontroller in the form of a neural network that is able to distinguish between a hazardous fire condition and a non-hazardous fire condition on the stove top. The neural network is trained by exposing the sensor unit to a variety of hazardous conditions and non-hazardous conditions and identifying to the neural network whether these conditions are hazardous or non-hazardous. Once the neural network has been trained, the sensor unit monitors the stove top and if it detects a hazardous condition, it signals the control unit, which turns the heat off on the stove top.

This is a continuation-in-part application of Application Serial No. 60/399,454, filed Jul. 30, 2002.

### FIELD OF THE INVENTION

The present invention relates to apparatuses and methods for sensing fire and smoke conditions on a cooking device, such as a stove, and for mitigating the fire and smoke conditions.

### BACKGROUND OF THE INVENTION

When cooking with grease, the risk of fire increases over greaseless cooking. Not only does the hot grease spatter, but it can be heated to a sufficiently high temperature to catch fire. If a pan of grease is left unattended and catches fire, significant fire damage can be done to the kitchen and house.

In the prior art, there exist fire extinguishers particularly adapted for stoves. One such fire extinguisher is described in U.S. Pat. No. 5,518,075. The device has a canister of fire extinguishing powder. Located above the stove, it contains a heat sensitive fuse and an explosive charge. If the stove becomes too hot, the canister opens and disburses the powder over the stove, extinguishing the fire.

The '075 device works well on traditional stoves and ranges. However, on stoves having microwave ovens located above the cooking elements, the microwave oven reduces the clearance at which the canister can be placed above the stove. When the canister is activated, the disbursal pattern of the powder is incomplete due to the low clearance.

### SUMMARY OF THE INVENTION

It is an object of the present invention to provide a method and apparatus for detecting fire conditions on a kitchen appliance such as a stove.

It is another object of the present invention to provide a method and apparatus for disabling the heat source on the kitchen appliance once a fire condition is detected.

The present invention provides an apparatus for detecting a hazardous fire condition. The apparatus comprises a stove top, an array of sensors and a processor. The stove top has one or more heating elements. The array of sensors senses at least two physical parameters of the stove top. The processor has inputs connected to the sensor array and an output to indicate the presence of a hazardous fire condition. The processor comprises a neural network that distinguishes a predetermined hazardous fire condition from a non-hazardous fire condition based upon the inputs and produces an output to indicate whether the condition is hazardous or non-hazardous.

In accordance with one aspect of the present invention, the sensor array comprises at least one temperature sensor and at least one combustion byproduct sensor.

In accordance with another embodiment, the sensor array comprises either an ultraviolet or an infrared sensor and a combustion byproducts chemical sensor, such as a carbon monoxide sensor or a hydrocarbon sensor.

In accordance with another aspect of the present invention, the output is communicated with the control unit and the control unit turns off the stove.

In accordance with another aspect of the present invention, the output is provided to the control unit by a wireless or wired channel.

In accordance with another aspect of the present invention, the sensor unit is located above the stove top, beneath a microwave oven.

In accordance with another aspect of the present invention, the sensor unit is located above the stove top, or in the air vent above the stove.

The present invention also provides a method of detecting hazardous fire conditions on a stove top. At least two physical parameters of the stove top are monitored. A neural network is provided having the monitored parameters as inputs. The neural network is trained to recognize a hazardous fire condition by providing plural fire conditions on the stove top and identifying to the neural network whether the fire conditions are hazardous or non-hazardous.

In accordance with another aspect of the present invention, the step of monitoring at least two physical parameters further comprises the step of monitoring temperature and at least one combustion byproduct.

In accordance with still another aspect of the preset invention, the step of monitoring at least physical parameters further comprises the step of monitoring at least one of ultraviolet or infrared light and combustion byproducts.

The present invention also provides a method of detecting hazardous fire conditions on a stove top. At least two physical parameters of the stove top are monitored. The monitored parameters are processed with a neural network. The neural network is trained to distinguish a hazardous fire condition from a non-hazardous fire condition. The heat produced by the stove top is turned off in the event that a hazardous condition is detected.

### BRIEF DESCRIPTION OF THE DRAWINGS

FIG. 1 is a schematic view of an electric stove with the apparatus of the present invention, in accordance with a preferred embodiment.

FIG. 2 is a schematic view of a gas stove with the apparatus of the present invention, shown in accordance with another embodiment.

FIG. 3 is a side view of the sensing unit.

FIG. 4 is a bottom plan view of the sensing unit.

FIG. 5 is a block diagram of the sensing unit.

FIG. 6 is a schematic diagram of the neural network for the sensing unit microcontroller.

FIG. 7 is a flow chart illustrating the training process for the sensing unit.

FIG. 8A is a flow chart illustrating the operation of the sensing unit.

FIG. 8B is a flow chart illustrating the operation of the control unit.

FIG. 9 is a schematic view of the control unit for use with an electric stove.

FIG. 10 is a block diagram of the control unit of FIG. 9.

FIG. 11 is a block diagram of the control unit for use with a gas stove.

FIG. 12 is a schematic cross-sectional view of the shut-off valve for use with a gas stove, shown in the open position.

FIG. 13 is a schematic cross-sectional of the valve of FIG. 12, shown in the closed position.

### DESCRIPTION OF THE PREFERRED EMBODIMENT

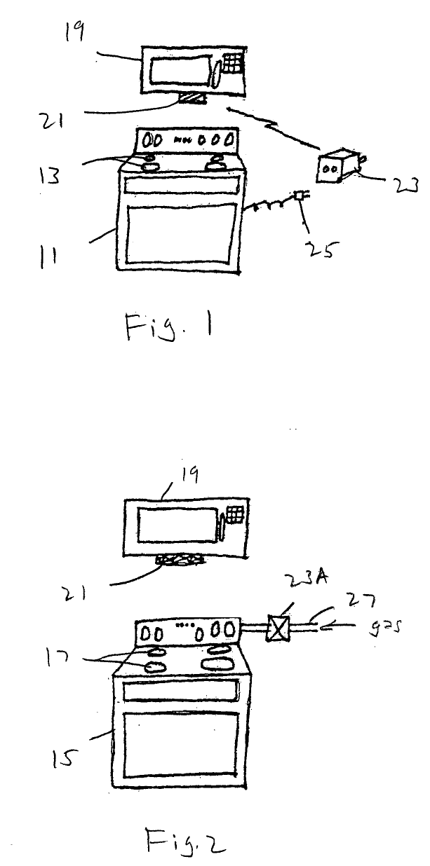

In FIG. 1, there is shown a stove 11 or range, as might be found in a kitchen of a residence or a business. The stove 11 is conventional, having an oven and a number of heating elements 13 on the stove top. The heating elements 13 can be of any type, such as electric resistance that contacts pots and pans, inductive heating, etc. Controls are provided to vary the heat produced by the heating elements.

The stove 11 of FIG. 1 is an electric stove. The stove 15 of FIG. 2 is similar, except that it is a gas stove, with heating elements in the form of gas burners 17 on the stove top. Both stoves have appliances, such as microwave ovens 19, located above the stove tops. Each microwave oven 19 is supported by a back wall or a cabinet that protrudes over the stove.

Each stove 11, 15 is provided with a sensing unit 21 and a control unit 23, 23A. The sensing unit 21 is located above the top of the stove so as to monitor potential fire, or other hazardous, conditions, such as overheating in a pot or pan or actual fire. In many cases, the sensing unit 21 is mounted underneath the microwave oven 19. The sensing unit 21 detects fire conditions and communicates with a control unit 23, 23A. The control unit 23, 23A controls the heat source for the stove. In the preferred embodiment, the control unit disables the heat source, wherein the fire is minimizes or extinguished. In the electric stove 11, the control unit 23 shuts off the electrical power 25 to the stove. In the gas stove 15, the control unit 23A shuts off the supply of gas 27.

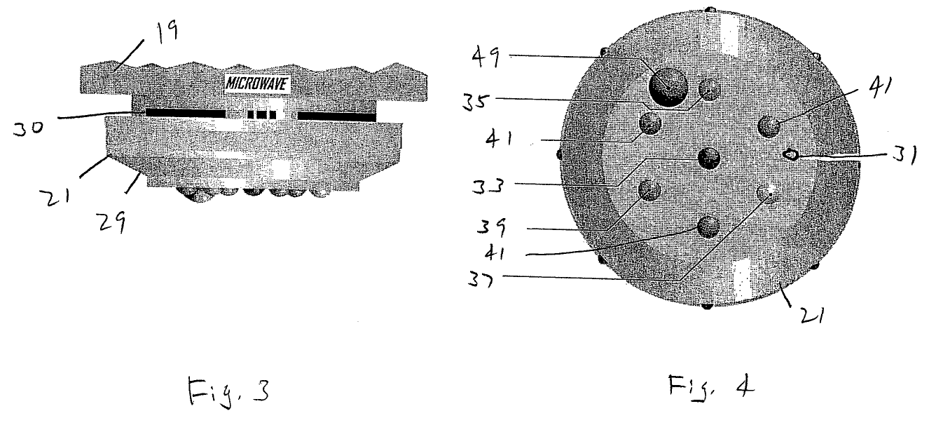

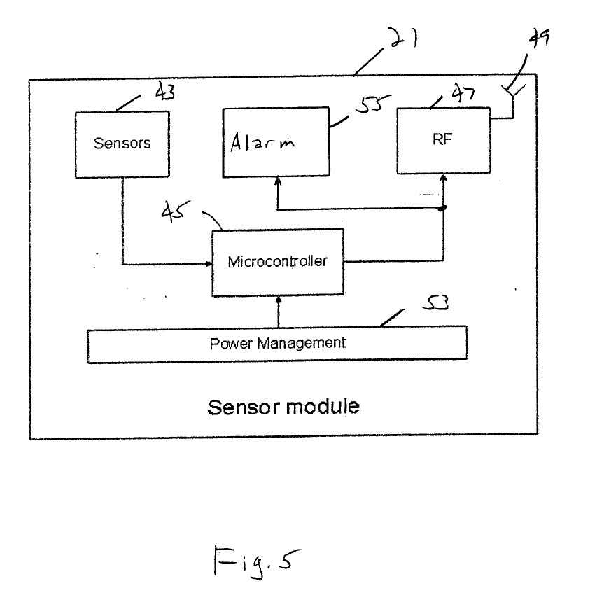

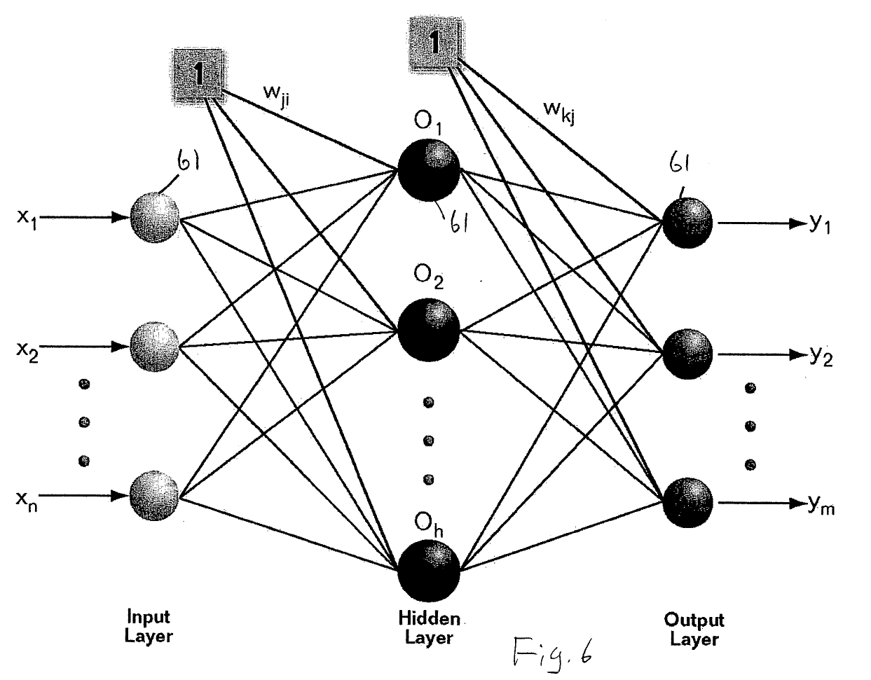

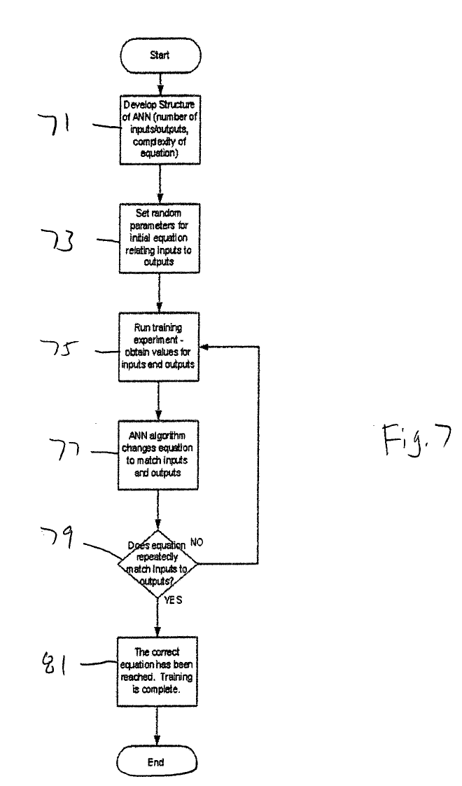

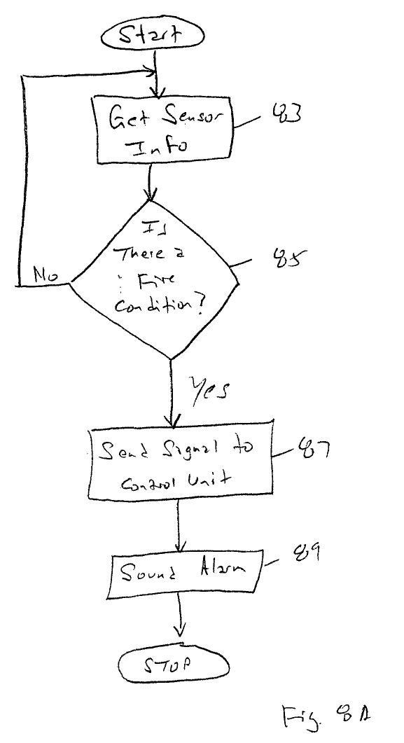

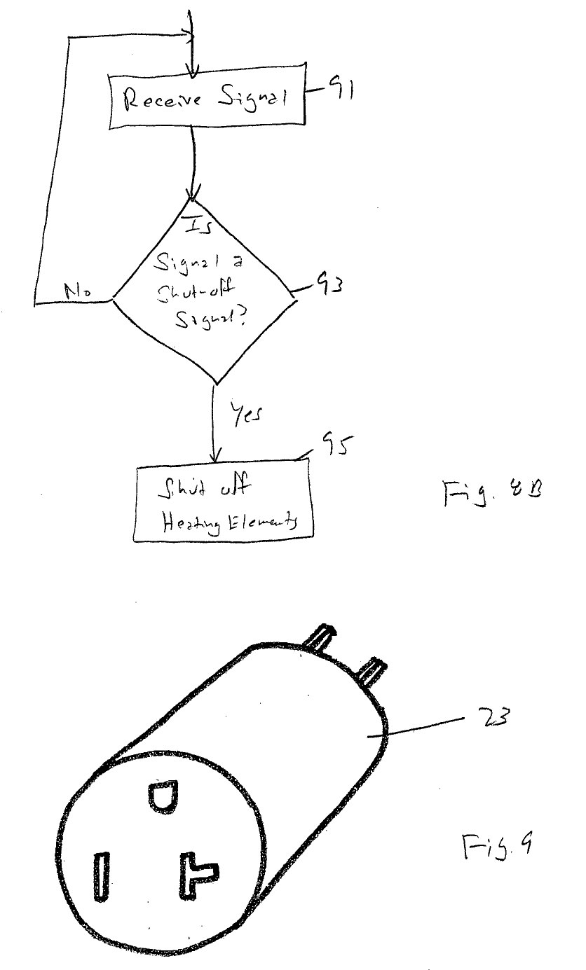

The sensing unit 21 is shown in FIGS. 3-5. The sensing unit 21 has a housing 29, or enclosure, for the electronics, which electronics are shown in FIG. 5. The electronics are sealed within the housing. If required, cooling media (liquid or air) can be included within the sensing unit. On the outside of the housing are a number of conventional and commercially available sensors. The sensing unit incorporates different types of sensors to monitor various physical parameters of the stove top. For example, there are optical type sensors for infrared (IR) (near and/or wideband) 31, visible type sensors (not shown) and ultraviolet (UV) sensors 33. In addition, there is a smoke sensor 35. The smoke sensor can be of the optical type, where smoke particles pass through a beam of light (visible or invisible) and cause the beam to flicker, with the detector monitoring the flickering. Alternatively, the smoke sensor could be of the ionizing type, where a weak radioactive source ionizes particles which are then sensed. Other types of sensors include a carbon monoxide sensor 37, a hydrocarbon sensor 39 and one or more temperature sensors 41. The smoke, carbon monoxide and hydrocarbon sensors monitor products of combustion.

The temperature sensors 41 are of the non-contact, or remote, type. Most commercial and scientific non-contact temperature sensors measure the thermal radiant power of the infrared or optical radiation that they receive. From that, the temperature of the object emitting the radiant power is inferred. Sensors which may be used for this application include the Raytek low-cost non-contact fixed mount infrared temperature sensors and Honeywell radiamatic detectors.

The sensors could be located inside the housing to protect them from exposure to high temperatures. If the sensors are located in the housing, then the housing is adapted to enable the sensors to work. For example, UV, visible and IR sensors can be protected by a window or lens made of quartz, sapphire or some other heat resistant material. Chemical sensors are exposed to ambient air by way of side vents 30.

The temperature sensors 41 are arrayed so as to monitor the entire stove top. Each sensor typically has a narrow field of vision. Preferably, the temperature sensors are oriented so that the respective fields of vision overlap slightly to ensure complete coverage of the stove top.

The array of sensors 31, 33, 35, 37, 39 and 41 provide spatial coverage of the stove top and also provide depth perception.

FIG. 5 shows a block diagram of the electronics and sensing unit 21. The sensors 43 are connected to the inputs of a microcontroller 45. The microcontroller 45 has an output that is provided to the control unit. In one embodiment, the sensing unit 21 is connected to the control unit by way of a wireless communications channel. In this embodiment, the sensing unit has an RF transmitter 47, which is connected to an antenna 49. The control unit 23 has a corresponding RF receiver 51 (see FIG. 10). Alternatively, the sensing unit 21 can be wired to the control unit 23A. A power management module 53 provides electrical power to the other components in the sensing unit 21. The power management module can be a battery or it can be connected to line voltage. The output of the microcontroller 45 can also be connected to an alarm 55 to alert an operator. The alarm 55 is either audio (such as a high volume enunciator) or visual (such as a flashing or blinking light) or both.

The microcontroller 45 processes the inputs from the sensors 43 and determines if there is a fire threat, or hazardous condition, on the stove top. In order to determine if a fire threat exists, the microcontroller utilizes a neural network. FIG. 6 illustrates a neural network, as embodied by a multi-layered perceptron. The network has various nodes 61 arranged in layers, such as an input layer, one or more hidden layers and an output layer. Each node 61 has one or more inputs and one or more outputs. Each input into a node has a weight (e.g. Wⱼᵢ, Wₖⱼ). Each node produces an output only when threshold levels of the one or more inputs are received. For example, the input layer nodes each have an input (Xₙ) and multiple outputs. The input layer outputs are connected to a hidden layer (Oₕ) as inputs. The outputs of the hidden layer are connected as inputs to the output layer. There may be one or more hidden layers.

The neural network represents a polynomial, with the nodes representing terms of the polynomial. Each term has a coefficient.

The advantage of using a neural network to detect a fire condition is that the network is trainable to be discerning among closely related fire conditions. The network is trained by exposing the sensors to a variety of conditions and the network is instructed whether each condition is hazardous or non-hazardous. After a number of training iterations, the network is set.

FIG. 7 illustrates the training procedure. In step 71, the structure of the neural network is developed. This includes developing the equation, based upon the number and type of sensor inputs, the outputs and the complexity. The sensor inputs vary depending upon the type of sensor. Most of the sensors produce a quantitative number of values; for example the temperature sensor. The network has a single output, which output produces either a “1” for a hazardous condition or a “0” indicating no hazardous condition. The complexity of the polynomial depends on how perceptive the network is to be. For example, if all open flames and smoke conditions are to be taken as hazardous conditions, then the polynomial will be relatively simple. However, if the network is to distinguish between the different types of open flames (hazardous flames from non-hazardous flames), then the polynomial will be relatively complex.

In step 73, random parameters and values are set for the initial equation, before training begins. In step 75, the training begins. The sensors are exposed to a particular condition with a defined output. For example, the sensors 43 are exposed to a pot of boiling water. The temperature sensor and IR sensor detect the rising heat from the pot of water. In addition, the pot may not fully cover the heating element, thereby producing a high temperature signature. The smoke, carbon monoxide and hydrocarbon sensors do not detect any increase (assuming an electric stove). The output is defined as a non-hazardous condition.

In step 77, the equation is changed so that the desired output is achieved. The equation is changed by changing the coefficients of the polynomial terms as represented by the nodes and in particular by changing the weights for the inputs.

The training process is then repeated, step 75, 77. The pot of boiling water is moved to a different heating element, for example, while more or less of the heating element can be uncovered by the pot. Also, different conditions are used, such as a bright room (with artificial light) a sunlit room and a dark room, as well as various types of cooking and various types of pots and pans. Also, the simultaneous use of multiple heating elements is used for training. Furthermore, some types of cooking that approach fire conditions (for example blackened fish) are used to train the network.

On a gas stove, the sensor unit 21 is trained to adjust to the open gas flame used to heat cooking pots and pans. The open flame produces carbon monoxide and hydrocarbon emissions. A gas stove open flame is indicated to be a non-hazardous condition.

The sensor unit 21 is also exposed to actual fire conditions which are determined to be hazardous, such as a grease fire.

In step 79, the method determines whether the polynomial is changed, or if the equation matches inputs to the outputs. If the equation has changed, then the result is NO and the process returns to step 75. If the result is YES, then the training is complete, step 81.

The goal is to train the network to identify a hazardous fire condition in the early stages, or even in the pre-ignition stage, so as to minimize damage.

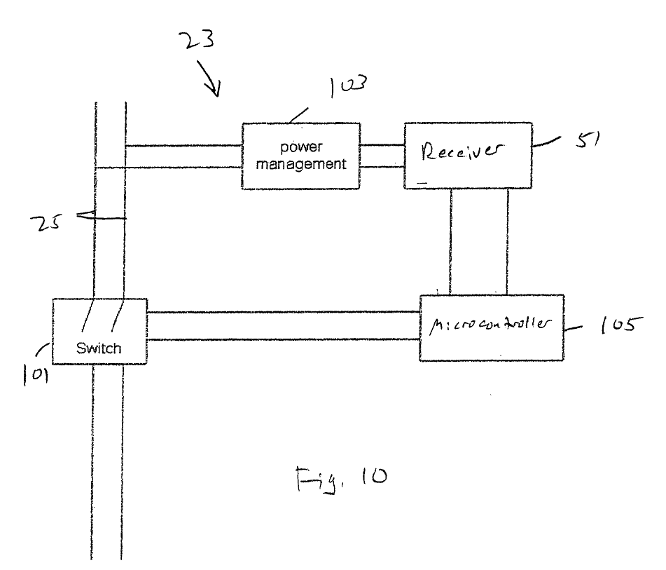

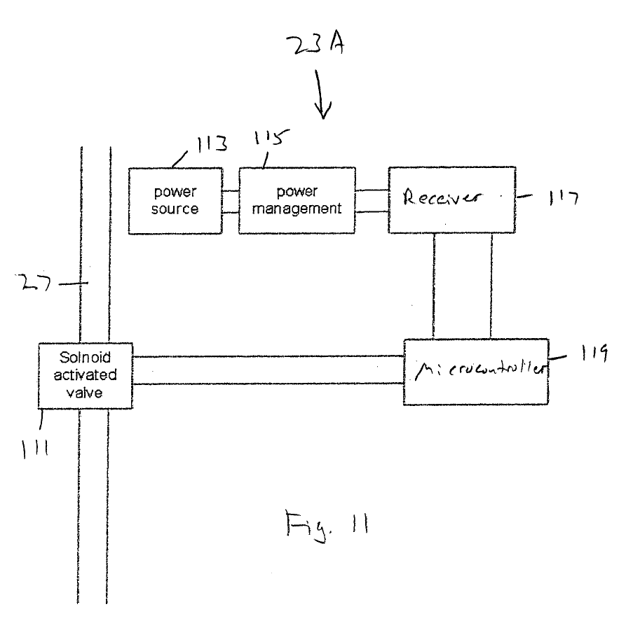

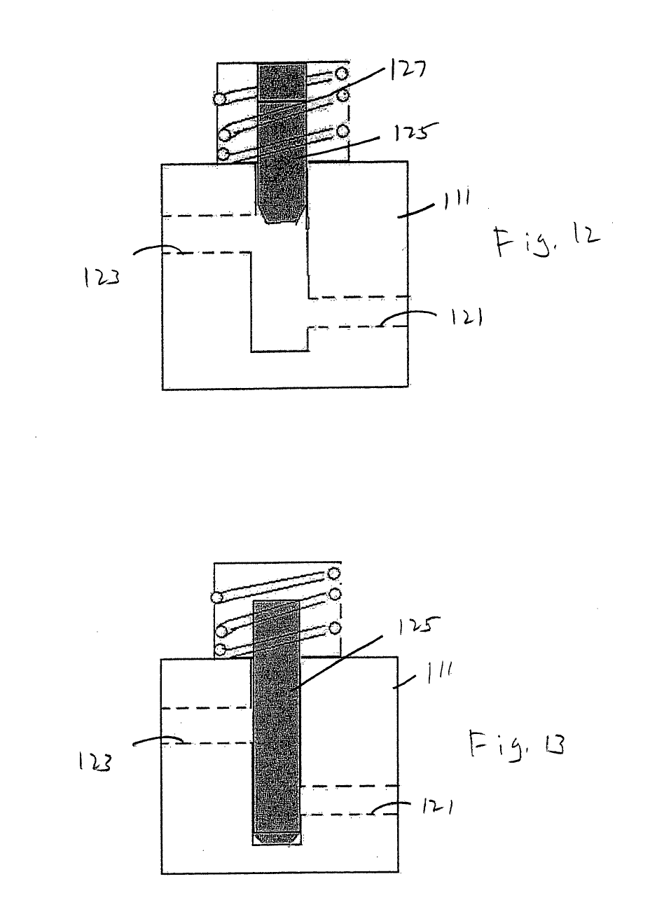

Once training is complete, the apparatus is ready for service. The apparatus will now be described with reference to the flow charts of FIGS. 8A and 8B. The sensors 43 monitor the physical parameters of the stove top and this information is passed as inputs to the microcontroller, step 83. The neural network in the microcontroller 45 determines if there is a hazardous condition, step 85. The most prevalent result is NO, so the process of steps 83 and 85 is repeated. The microcontroller periodically polls the sensor data so as to constantly monitor the stove top.

If a hazardous condition is detected by the microcontroller 45 neural network, then the result of step 85 is YES and the output is changed. A signal is sent to the control unit, step 87 by the transmitter 47 and the alarm 55 is sounded, step 89.

In FIG. 8B, the control unit receiver 51 (see FIG. 10) receives the signal, step 91. The microcontroller 205 verifies the signal as a shut-off signal, step 93. If the signal is not a shut-off signal, then the method returns to step 91 to await reception of the signal. If a shut-off signal is verified, then in step 95, the control unit shuts off the energy source. Thus, the fire will not intensify and will usually become extinguished as the stove cools.

FIG. 9 shows the control unit 23 for an electric stove. The control unit 23 plugs in line with the power conductors 25 (see FIG. 1) of the stove. FIG. 10 shows a block diagram of the control unit 23. A switch 101 is located in series with the power conductors 25 that heat the heating elements. A power management module 103 is connected to the power conductors 25 so as to power the remaining components of the control unit. The control unit need not have a power source independent of the stove. A receiver 51 receives the signal from the sensing unit 21 and provides an input to a microcontroller 105. When the receiver 51 receives a signal, it produces an output to the microcontroller 105. The microcontroller verifies the signal as a shut-off signal. If verified, the microcontroller 105 opens the switch 101 and interrupts power to the stove and the heating elements. The control unit can also include A/D converters and signal conditioning circuitry.

FIG. 11 shows a block diagram for the control unit 23A for a gas stove. The control unit has a solenoid activated valve 111 which is connected in-line to the gas line 27. The control unit also has an electrical power source, which may be a battery or simply line voltage. A power management module 115 provides power to the electronic components of the control unit. A receiver 117 receives signals and a microcontroller 119 verifies the signals as a shutoff signal or a non-shutoff signal. When a shutoff signal is received, the microcontroller 119 causes the solenoid activated valve to close.

FIGS. 12 and 13 show schematically a shutoff valve 111. The valve has an inlet passage 121 and an outlet passage 123. Located between the two passages is a plunger 125. The plunger is normally open, as shown in FIG. 12. However, when activated, the spring forces the plunger 125 into the closed position as shown in FIG. 13. A seal is provided around the plunger so that gas will not leak from the inlet passage to the outlet passage 123.

As an alternative, the temperature sensors could be of the contact type, in contact with a cooking utensil (pot or pan) on the stove. This would allow more precise monitoring and prediction of a fire. A low-powered (2.7 v supply) programmable logic output temperature detector can be used, in which the output is activated when the temperature exceeds a pre-programmed threshold value. One example of this kind of sensor is the simple, low cots TC07VUA temperature sensor with digital output (available from Microchip Technology).

Also, the control unit can provide additional control of the stove, other than merely turning the heating elements off. In an electric stove, for example, the control unit can reduce the electrical power to the heating element so as to allow the stove top to cool, without completely shutting off the heating elements. The control unit can electronically control the electrical power, or the control unit could use a small motor to turn each control knob of the stove (for older stoves or gas stoves). A position sensor determines the knob position and turns the motor position.

After a hazardous condition has gone away, if the sensor unit detects a change to a non-hazardous condition, the sensor unit can change its output. This is received by the control unit, which then turns the heating elements back on. Such an on-off-on control allows the neural network to look for pre-fire conditions and take action to prevent a fire from occurring. Hysteresis is used to control the turn-on and turn-off parameters (such as temperatures) in order to prevent the heating elements from rapidly cycling on and off. For example, when the temperature exceeds the set-point temperature, the heating element is turned off. When the temperature drops to a lower set-point temperature, the heating element is turned on.

The foregoing disclosure and showings made in the drawings are merely illustrative of the principles of this invention and are not to be interpreted in a limiting sense.

1. An apparatus for detecting a hazardous fire condition, comprising:
a) a stove top having one or more heating elements;
b) an array of sensors for sensing at least two physical parameters of the stove top;
c) a processor having inputs connected to the sensor array, and an output to indicate the presence of a hazardous fire condition, the processor comprising a neural network that distinguishes a predetermined hazardous fire condition from a non-hazardous fire condition based upon the inputs and produces an output to indicate whether the condition is hazardous or non-hazardous.

2. The apparatus of claim 1 wherein the sensor array comprises at least one temperature sensor and at least one optical sensor.

3. The apparatus of claim 2 wherein the optical sensor comprises an ultraviolet light sensor.

4. The apparatus of claim 2 wherein the optical sensor comprises an infrared sensor.

5. The apparatus of claim 1 wherein the sensor array comprises at least one of an ultraviolet or infrared sensor and a combustion byproduct sensor.

6. The apparatus of claim 5 wherein the combustion byproduct sensor comprises a carbon monoxide sensor.

7. The apparatus of claim 5 wherein the combustion byproduct sensor comprises a hydrocarbon sensor.

8. The apparatus of claim 1 wherein:
a) the output is provided to a control unit;
b) the control unit turns off the stove heating elements in response to a hazardous condition output.

9. The apparatus of claim 8 wherein the output is provided to the control unit by a wireless channel.

10. The apparatus of claim 1 wherein the sensor unit is located above the stove top, beneath a microwave oven.

11. A method of detecting hazardous fire conditions on a stove top, comprising the steps of:
a) monitoring at least two physical parameters of the stove top;
b) providing a neural network having the monitored parameters as inputs;
c) training the neural network to recognize a hazardous fire condition by providing plural fire conditions and identifying to the neural network whether the fire conditions are hazardous or non-hazardous.

12. The method of claim 11 wherein the step of monitoring at least two physical parameters further comprises the step of monitoring temperature and at least one of ultraviolet or infrared light radiation.

13. The method of claim 11 wherein the step of monitoring at least two physical parameters further comprises the step of monitoring at least one of ultraviolet or infrared light radiation and combustion byproducts.

14. A method of detecting hazardous fire conditions on a stove top, comprising the steps of:
a) monitoring at least two physical parameters of the stove top;
b) processing the monitored parameters with a neural network, the neural network having been trained to distinguish a hazardous fire condition from a non-hazardous condition;
c) turning off the heat produced by the stove top in the event that a hazardous fire condition is detected.
